(19) United States
(12) Patent Application Publication
(10) Pub. No.: US 2023/0217896 A1
(43) Pub. Date: Jul. 13, 2023

(54) TRAINING BOX DEVICE FOR A DOG

(71) Applicant: Charles Julien, Reserve, LA (US)

(72) Inventor: Charles Julien, Reserve, LA (US)

(21) Appl. No.: 18/074,338

(22) Filed: Dec. 2, 2022

Related U.S. Application Data
(60) Provisional application No. 63/299,300, filed on Jan. 13, 2022.

(51) Int. Cl. A01K 15/02

(52) U.S. Cl. CPC A01K 15/02

(57) ABSTRACT

A training box device for a dog is disclosed to efficiently develop the dog into a confident and well-mannered family member, to improve the pet owner's everyday life. The training box device comprises a bottom panel that is fixed to a first side panel and a second side panel. The training box device includes a front panel that is fixed to the bottom panel as well as fixed to the first side panel and the second side panel. A handle is operatively connected to an outer surface of the front panel. The training box device includes an accomplishment chart fixed to at least an outer surface of the first side panel, an outer surface of the second side panel, or an outer surface of the front panel. The training box device has at least one removably magnetically adhered accomplishment mark removably fixed to the accomplishment chart.

### CROSS-REFERENCE TO RELATED APPLICATIONS

This application claims the benefit of priority of pending U.S. Provisional Application No. 63/299,300, filed Jan. 13, 2022, the full disclosure of which is hereby incorporated by reference in its entirety.

### BACKGROUND OF THE INVENTION

### Field of the Invention

The present invention generally relates to a training device for pets and more particularly relates to a training device for dogs.

### Description of the Related Art

With the growing population of domesticated pets, pet animal owners have the responsibility to train their pets in an effort to build confidence, provide mental stimulation and strengthen the human-animal bond. As a pet, it is important to a dog to have good posture, muscular balance, muscle memory and flexibility. Proper alignment of a pet's body parts promotes efficiency of movement and endurance.

The manner and devices with which a person trains a dog should teach a new technique or behavior as well as modify an existing behavior. Currently, a common device for training dogs is a clicker, which like treats, can play a key role in positive reinforcement training. A clicker and a treat are usually used in combination when training a dog, until the dog associates the sound of the clicker with good behavior without receiving a treat. However, a clicker does not directly contribute to the good physical posture of the dog.

Another common device for training dogs is a training collar, such as a choke, pinch or prong training collar, which typically restrains a dog's mouth, where such restraint is tethered to the dog's collar and leash, to be controlled by the dog owner or dog trainer. However, such choke, pinch or prong training collars can hurt a dog's neck if put on too tightly or if the dog fights against it.

Yet another conventional device for training dogs is a durable chew toy. Puppies love to bite, especially when playing or teething, which is normal and necessary for stress relief and maturing. The key is to redirect negative chewing on furniture or an outstretched hand to a chew toy instead. However, durable chew toys doe not directly contribute to the good physical posture of the dog and thus does not promote proper alignment and posture of a pet's body parts, nor do durable chew toys promote efficiency of movement and endurance.

There exists a need for a dog training device for pet owner's to easily and efficiently train their dogs where the device physically promotes proper alignment of your pet's body parts and promotes efficiency of movement and endurance.

Proper training and socialization at an early age helps to ensure that puppy will develop into a confident and well-mannered family member. The right training tools not only help with the puppy training process, but they can also speed things up. The faster behaviors stick, the sooner a dog owner can enjoy the way they improve everyday life with his/her dog.

While conventional devices may be suitable for the particular purpose employed, they would not be as suitable for the purposes of the present invention as disclosed hereafter.

Accordingly, there is a need for a dog training device for training dogs for good posture, muscular balance, muscle memory, and flexibility, in a more convenient and effective manner.

As disclosed in this application, the inventor has discovered a novel and unique device and method for efficient training of dogs, which exhibits superlative properties without being dependent on expensive or complex components.

Embodiments of the present invention provide for a device and a method as disclosed herein and as defined in the annexed claims which provide for improved training of dogs in order to efficiently ensure that a pet owner's dog will develop into a confident and well-mannered family member, exhibiting proper behaviors, which improve the pet owner's everyday life with the dog.

### SUMMARY OF THE INVENTION

It is one prospect of the present invention to provide one or more novel devices of simple but effective construction which can be applied to many environments to efficiently and effectively train dogs where the device physically promotes proper alignment of the dog's body parts and promotes efficiency of movement and endurance.

The following presents a simplified summary of the present disclosure in a simplified form as a prelude to the more detailed description that is presented herein.

Therefore, in accordance with embodiment of the invention, there is provided a training box device for a dog, to efficiently develop the dog into a confident and well-mannered family member, exhibiting proper behaviors, which improve the pet owner's everyday life.

In a preferred embodiment, the training box device for a dog comprises a bottom panel having a proximal end opposite a distal end. The bottom panel has a first side opposite a second side.

The training box device for a dog includes a front panel having a first side edge opposite a second side edge. The front panel has a bottom edge opposite a top edge. Preferably, the bottom edge of the front panel is fixed to and extends perpendicularly upward from the proximal end of the bottom panel. In one embodiment, the bottom edge of the front panel is fixed to the proximal end of the bottom panel with an L-shaped bracket and respective fasteners. The L-shaped bracket and respective fasteners are each forged of metal.

In a preferred embodiment, the bottom edge of the front panel is fixed to the proximal end of the bottom panel with a plurality of L-shaped brackets, and respective fasteners. The plurality of L-shaped brackets and respective fasteners are preferably each forged of metal.

The training box device for a dog further includes a first side panel having a proximal end opposite a distal end. The first side panel has a bottom edge opposite a top edge. The bottom edge of the first side panel is fixed to and extends perpendicularly upward from the first side of the bottom panel.

In one embodiment, the bottom edge of the first side panel is fixed to the first side of the bottom panel with an L-shaped bracket and respective fasteners. The L-shaped bracket and respective fasteners are preferably each forged of metal. In a preferred embodiment, the bottom edge of the first side panel is fixed to the first side of the bottom panel with a plurality of L-shaped brackets and respective fasteners.

The proximal end of the first side panel is fixed to the first side edge of the front panel, preferably with an L-shaped bracket and fasteners, and the L-shaped bracket and fasteners are preferably each forged of metal.

The training box device for a dog further includes a second side panel having a proximal end opposite a distal end, and the second side panel has a bottom edge opposite a top edge. The bottom edge of the second side panel fixed to and extends perpendicularly upward from the second side of the bottom panel. In one embodiment, the bottom edge of the second side panel is fixed to the second side of the bottom panel with an L-shaped bracket and respective fasteners. The L-shaped bracket and respective fasteners are preferably each forged of metal. In a preferred embodiment, the bottom edge of the first side panel is fixed to the first side of the bottom panel with a plurality of L-shaped brackets and respective fasteners.

The proximal end of the second side panel is fixed to the second side edge of the front panel, preferably with an L-shaped bracket and fasteners, and the L-shaped bracket and fasteners are preferably each forged of metal.

In one embodiment, the training box device is fabricated from steel, and the training box device comprises an accomplishment chart fixed to at least an outer surface of the first side panel, an outer surface of the second side panel, or an outer surface of the front panel. The accomplishment chart preferably comprises at least one removably magnetically adhered accomplishment mark. The at least one removably magnetically adhered accomplishment mark is preferably a magnet, in the form of a checkmark, adapted to be removably connected to the outer surface of the first side panel, the second side panel, and/or the front panel, at the option of the user, such as the dog's owner, handler or trainer. The user can place the at least one removably magnetically adhered accomplishment mark on one of such panels of the training box device, in order to keep track of the dog's progress during training including any accomplishments of the dog during the dog's training process. The accomplishment chart is preferably inscribed with words or abbreviations designating days of the week along a top row thereof; and the accomplishment chart is preferably inscribed with words or abbreviations designating tasks or goals for the dog along a first column of the accomplishment chart.

In a preferred embodiment, the training box device for a dog includes a handle operatively connected to an outer surface of the front panel. The handle is configured to be grasped by a user's hand to maneuver said device. In one embodiment, the handle comprises a first end opposite a second end. The first end comprises at least a first fastener fixed to the front panel, and the second end comprises at least a second fastener fixed to the front panel.

Preferably, the bottom panel, first side panel, second side panel and front panel are constructed of fabricated of wood, such that the training box device for a is constructed of wood and metal.

In another embodiment, the training box device for a dog is of unitary construction forged from a material selected from a group consisting of plastic, resin, high-density polyethylene, rubber, and steel.

These and other features, aspects, and advantages of the present invention will become better understood with reference to the following description and appended claims.

### BRIEF DESCRIPTION OF THE DRAWINGS

Illustrative embodiments of the present invention are described herein with reference to the accompanying drawings, in which like numerals throughout the figures identify substantially similar components, in which:

FIG. 1 is a front perspective view of a training box device and an exemplary dog in accordance with embodiments of the invention;

FIG. 2 is a back perspective view of a training box device with an exemplary dog sitting inside the training box, in accordance with embodiments of the invention;

FIG. 3 is a front perspective view of a training box device for a dog in accordance with embodiments of the invention;

FIG. 4 is a right side perspective view of a training box device for a dog in accordance with embodiments of the invention; and

FIG. 5 is a top perspective view of a training box device for a dog in accordance with embodiments of the invention.

### DETAILED DESCRIPTION

For a further understanding of the nature and function of the embodiments, reference should be made to the following detailed description. Detailed descriptions of the embodiments are provided herein, as well as, the best mode of carrying out and employing the present invention. It will be readily appreciated that the embodiments are well adapted to carry out and obtain the ends and features mentioned as well as those inherent herein. It is to be understood, however, that the present invention may be embodied in various forms. Therefore, persons of ordinary skill in the art will realize that the following disclosure is illustrative only and not in any way limiting, as the specific details disclosed herein provide a basis for the claims and a representative basis for teaching to employ the present invention in virtually any appropriately detailed system, structure or manner. It should be understood that the devices, materials, methods, procedures, and techniques described herein are presently representative of various embodiments. Other embodiments of the disclosure will readily suggest themselves to such skilled persons having the benefit of this disclosure.

As used herein, “axis” means a real or imaginary straight line about which a three-dimensional body is symmetrical. A “vertical axis” means an axis perpendicular to the ground (or put another way, an axis extending upwardly and downwardly). A “horizontal axis” means an axis parallel to the ground.

As used herein, homogeneous is defined as the same in all locations, and a homogeneous material is a material of uniform composition throughout that cannot be mechanically separated into different materials. Examples of “homogeneous materials” are certain types of plastics, ceramics. glass, metals. alloys, paper. board, resins. high-density polyethylene and rubber.

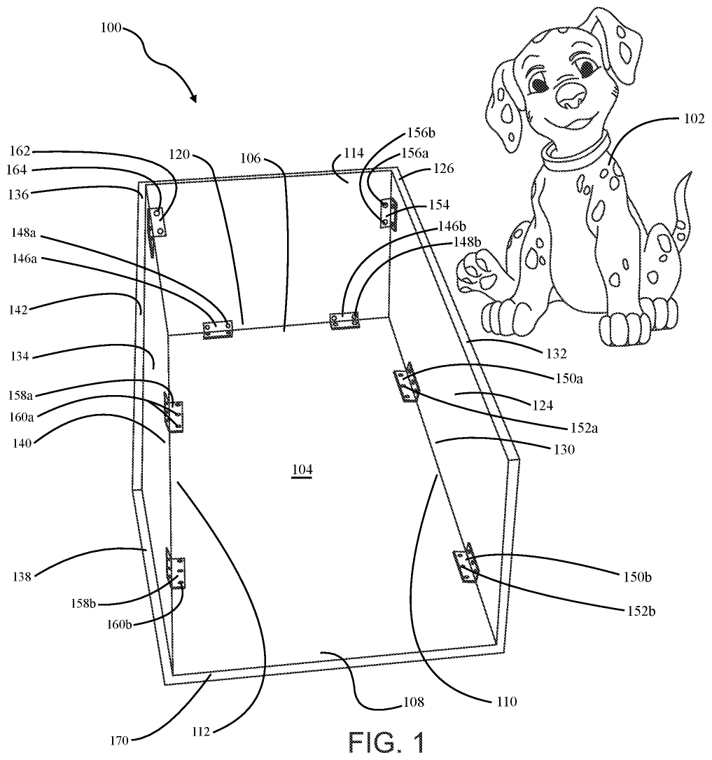

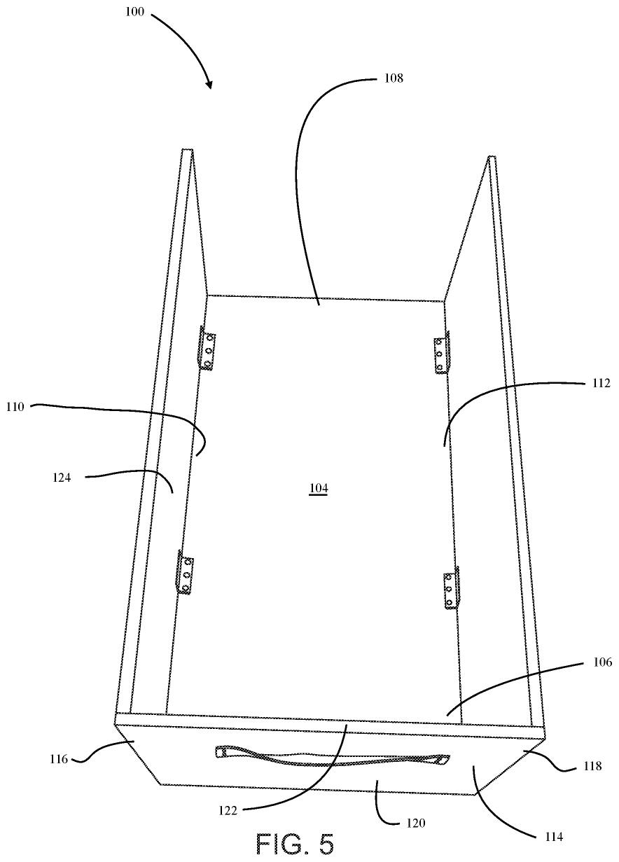

Referring to FIGS. 1-5, the basic constructional details and principles of operation of one embodiment of a training box device 100 for a dog 102 according to preferred embodiments of the present invention will be discussed.

In FIG. 1, a training box device 100 for a dog 102 according to a preferred embodiment of the present invention is provided. As illustrated in FIG. 1, the training box device 100 comprises a bottom panel 104 having a proximal end 106 opposite a distal end 108. The bottom panel 104 has a first side 110 opposite a second side 112.

In one embodiment, the bottom panel 104 is fabricated of wood. In yet another embodiment, the bottom panel 104 is made of steel.

In another embodiment, training box device 100 is constructed of a composite material.

Preferably, the training box device 100 is of unitary construction, comprising a homogenous material, fabricated from a material selected from the group consisting of plastic, resin, epoxy, high density polyethylene, rubber, and steel.

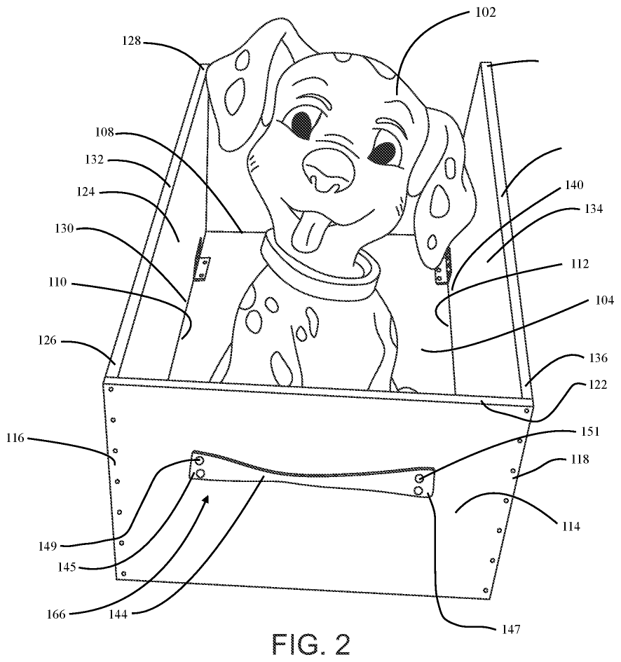

Referring to FIGS. 1-2, the training box device 100 for a dog 102 includes a front panel 114 having a first side edge 116 opposite a second side edge 118. The front panel 114 has a bottom edge 120 opposite a top edge 122.

In one embodiment, the front panel 114 is fabricated of wood. In another embodiment, the front panel 114 is made of steel.

Preferably, as seen in FIG. 1, the bottom edge 120 of the front panel 114 is fixed to and extends perpendicularly upward from the proximal end 106 of the bottom panel 104. In one embodiment, the bottom edge 120 of the front panel 114 is fixed to the proximal end 106 of the bottom panel 104 with an L-shaped bracket 146a and respective fasteners 148a. The L-shaped bracket 146a and respective fasteners 148a are each forged of metal.

In a preferred embodiment, the bottom edge 120 of the front panel 114 is fixed to the proximal end 106 of the bottom panel 104 with a plurality of L-shaped brackets 146a, 146b and respective fasteners 148a, 148b, as seen in FIG. 1. In such embodiment, the front panel 114 is fabricated of wood, and the plurality of L-shaped brackets 150a, 150b and respective fasteners 1552a, 152b are preferably each forged of metal. In another embodiment, the bottom edge 120 of the front panel 114 is welded to the bottom panel 104, wherein the front panel 114 and bottom panel 104 are each fabricated of steel.

The training box device 100 for a dog 102 further includes a first side panel 124 having a proximal end 126 opposite a distal end 128. The first side panel 124 has a bottom edge 130 opposite a top edge 132. The bottom edge 130 of the first side panel 124 is fixed to the bottom panel 104, where the first side panel 124 extends perpendicularly upward from the first side 110 of the bottom panel 104, as illustrated in FIGS. 1-5.

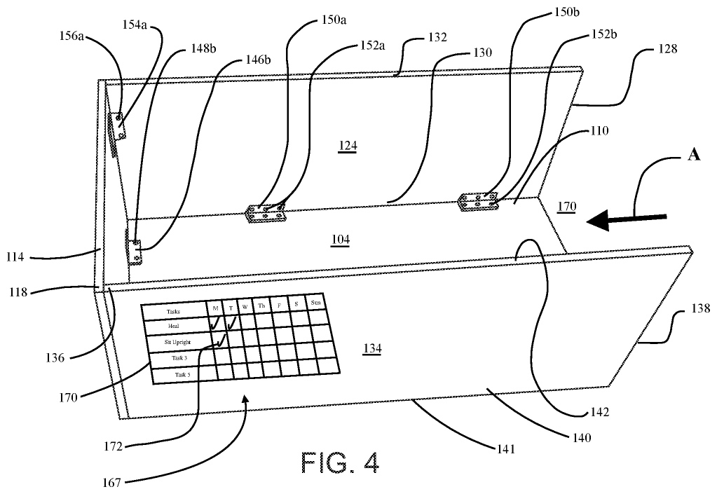

Referring to FIG. 4, in one embodiment, the bottom edge 130 of the first side panel 124 is fixed to the first side 110 of the bottom panel 104 with at least one L-shaped bracket 150a and respective fasteners 152a. The at least one L-shaped bracket 150a and respective fasteners 152a are preferably all forged from metal.

In a preferred embodiment, the bottom edge 130 of the first side panel 124 is fixed to the first side 110 of the bottom panel 104 with a plurality of L-shaped brackets 150a, 150b and respective fasteners 152a, 152b, as exemplified in FIG. 4. In such embodiment, the first side panel 124 is fabricated of wood, and the plurality of L-shaped brackets 150a, 150b and respective fasteners 152a, 152b are preferably all forged from metal.

In another embodiment, the first side panel 124 is welded to the bottom panel 104, wherein the first side panel 124 and bottom panel 104 are both fabricated or forged from steel.

Referring to FIGS. 1, 3, and 4, in a preferred embodiment, the proximal end 126 of the first side panel 124 is fixed to the first side edge 116 of the front panel 114, preferably with an L-shaped bracket 154 and fasteners 156a, 156b, as illustrated in FIG. 1, and the L-shaped bracket 154 and fasteners 156a, 156b are preferably each forged of metal.

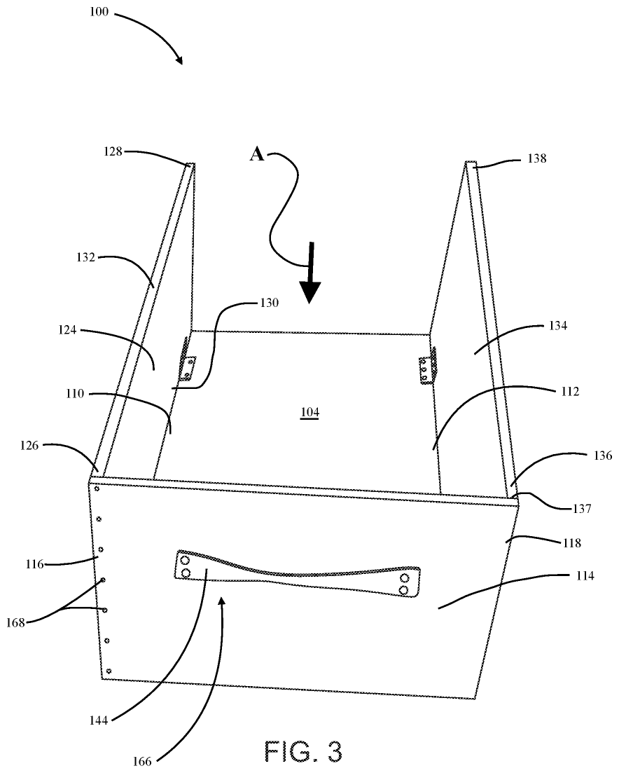

Referring to FIG. 3, in another embodiment, the proximal end 126 of the first side panel 124 is directly fixed to the first side edge 116 of the front panel 114 with a plurality of fasteners 168, as illustrated in FIG. 3.

In yet another embodiment, the proximal end 126 of the first side panel 124 is welded to the first side edge 116 of the front panel 114, wherein the first side panel 124 and front panel 114 are each fabricated of steel.

As illustrated in FIGS. 1-5, the training box device 100 for a dog 102 further includes a second side panel 134 having a proximal end 136 opposite a distal end 138, and the second side panel 134 has a bottom edge 140 opposite a top edge 142. The bottom edge 140 of the second side panel 134 fixed to and extends perpendicularly upward from the second side 112 of the bottom panel 104.

In a preferred embodiment, the bottom edge 130 of the first side panel 124 is fixed to the first side 110 of the bottom panel 104 with the plurality of L-shaped brackets 150a, 150b and the respective plurality of fasteners 152a, 152b, as exemplified in FIGS. 1 and 4.

In another embodiment, the bottom edge 130 of the first side panel 124 is welded to the first side 110 of the bottom panel 104, wherein the first side panel 124 and bottom panel 104 are each fabricated of steel.

Referring to FIG. 1, in one embodiment, the bottom edge 140 of the second side panel 134 is fixed to the second side 112 of the bottom panel 104 with a plurality of L-shaped brackets 158a, 158b and respective fasteners 160a, 160b, as seen in FIG. 1. The L-shaped brackets 158a, 158b and respective fasteners 160a, 160b are preferably each forged of metal. In such embodiment, the second side panel 134 is preferably fabricated of wood, and the plurality of L-shaped brackets 158a, 158b and respective fasteners 160a, 160b are preferably each forged of metal.

In another embodiment, the second side panel 134 is welded 141 to the bottom panel 104, wherein the second side panel 134 and bottom panel 104 are each fabricated of steel, as illustrated in FIG. 4.

Referring to FIGS. 1-2, in a preferred embodiment, the proximal end 136 of the second side panel 134 is fixed to the second side edge 118 of the front panel 114, preferably with at least one L-shaped bracket 162 and a plurality of fasteners 164, and the L-shaped bracket 162 and fasteners 164 are preferably all forged of metal, as illustrated in FIG. 1.

Referring to FIG. 3, in another embodiment, the proximal end 136 of the second side panel 134 is welded 137 to the second side edge 118 of the front panel 114, wherein the second side panel 134 and front panel 114 are preferably both fabricated of steel.

In a preferred embodiment, referring to FIG. 2, the training box device 100 for a dog includes a handle 144 operatively connected to an outer surface 166 of the front panel 114. The handle 144 is configured to be grasped by a user's hand to maneuver said device 100. In one embodiment, the handle 144 has a first end 145 opposite a second end 147. The first end 145 includes at least a first fastener 149 fixed to the front panel 114, and the second end 147 includes at least a second fastener 151 fixed to the front panel 114. In one embodiment, the handle 144 is fabricated of leather. In another embodiment, the handle 144 is made of rope.

As seen in FIG. 2, the training box device 100 for a dog 102 provides for good posture of the dog 102 when the dog 102 sits within the training box device 100. As illustrated in FIGS. 1, 2 and 4, a back end 170 of the training box device 100 is open, as defined by distal end 128 of the first side panel 124 and the distal end 138 of the second side panel 134, allowing the dog 102 to walk into training box device 100, in the direction of Arrow A (FIGS. 3-4), to sit on the bottom panel 104 and abut the dog's chest up against the front panel 114, with the dog's head positioned upright and at attention. As disclosed herein, the first side panel 124 and the second side panel 134 prevent the dog 102 from moving laterally, side-to-side, thereby assisting the dog 102 to achieve to muscular balance, muscle memory, and flexibility, in a more convenient and effective manner than otherwise attempted by conventional devices.

In other words, the first side panel 124, the second side panel 134, and the front panel 114 of the training box device 100 prevent the dog 102 from leaning to the front nor to the side. Such leaning would promote bad posture for the dog. As disclosed herein, the training box device 100 provides for good posture for the dog 102. Accordingly, using the training box device 100 will correct a dog's bad sitting habits and will reinforce good sitting habits.

The training box device 100 assists an owner in training the dog 102 from a mechanical standpoint. While the dog 102 sits in good posture, the bones and joints of the dog 102 are in position to alleviate the stress of weight and movement of the dog 102 being trained. The musculature is firmly balanced to hold the dog's body organs in place for whatever events are intended for the dog 102. If a dog has poor posture, his or her bones are out of line, and dog's muscles and ligaments take more strain than nature intended. Such is unattractive and may cause faulty posture or may cause fatigue or muscular strain. Also, in a pet's later stages of life, bad posture may cause pain. In some cases, poor posture affects the position and functioning of vital organs, particularly those of the abdominal region, causing a trainee dog to be lackluster in shows that the dog may have otherwise been able to win. Muscular strength is essential to good posture, and it is important that such strength be well-balanced. As disclosed herein, the training box device 100 is designed to reinforce posture when training one's dog.

An owner or trainer should observe one's dog 102 as objectively as possible when trying to determine the source of problems, because doing so will assist the owner or trainer to understand what might be triggering unwanted behaviors. It is also important to involve everyone in one's household in the game plan to try to solve problems unwanted behaviors.

As disclosed herein, the training box device 100 is preferably a three-sided box used to train dogs 102 for good posture, muscular memory, muscle memory, and flexibility, as illustrated in FIG. 2. It is important for one's dog to properly function during training exercises. The disclosed training box device 100 contributes to one's pet's overall good appearance. Proper alignment of one's pet's body parts promotes efficiency of movement and endurance.

The disclosed training box device 100 is preferably used when training one's dog for specific commands. It can also be used to teach a new techniques or behavior, as well as, modify an existing behavior. The disclosed training box device 100 corrects “bad habits” that might be picked up from not always being consistent, and it does so while training/reinforcing the dog's “good habits.” Of course, it is important to remember that each pup or dog is his/her own individual. Sometimes advice given has worked for many dogs, as well as, their handlers or owners.

The training box device 100 can be used to teach new behavioral techniques and to modify an existing behavioral technique as a trainer trains the trainee dog. Not developing strength in certain muscles, while strengthening the opposite muscles, will tend to distort a dog's alignment rather than promote good posture for proper training. Flexibility depends on free joint motion and muscle length.

Puppies tend to be very flexible, and it is natural that they lose some of this flexibility along with developing more strength as they grow older. The training box device 100 is advantageous for molding the puppy while the puppy is young. One major benefit of training with the training box device 100 while one's dog is young is to focus on and to train “muscle memory.”

Muscle memory is known as a form of procedural memory that involves consolidating specific motor skills or tasks by using repetition of that group of muscles. Moreover, it is essential to use consistent responses when training one's dog, on every level, because when an owner or trainer is inconsistent in communication, while training, such can confuse the dog 102. The last thing an owner or handler wants to do is accidentally reinforce undesired behaviors.

The training box device 100 disclosed herein is advantageous for the average puppy as well as for adult dogs, to promote good flexibility and to reinforce muscle memory for good posture. The training box device 100 also helps strengthen muscles the right way for the right form, as exemplified in FIG. 2.

When a dog's muscles contract properly by being trained the correct way, with the use of the training box device 100, then those muscles move the bones to which they attach closer together. When muscles lengthen, they must relax, allowing the bones to which they attach to move away from each other with proper form. While it is important to be able to shorten or to stretch muscles through a good range of motion, it is also very important that they do so with proper form. The training box device 100 reinforces consistency for proper muscle memory of a dog.

The training box device 100 is designed for an owner, handler, or trainer whose intention is to train his/her pet to have good posture, one who moves gracefully, and one who projects poise, confidence, and dignity.

Referring to FIG. 4, in one embodiment, the training box device 100 is fabricated from steel, and the training box device 100 comprises an accomplishment chart 170 fixed to an outer surface 167 of the second side panel 134, and the accomplishment chart 170 comprises at least one removably magnetically adhered accomplishment mark 172. The at least one removably magnetically adhered accomplishment mark 172 is preferably a magnet, in the form of a checkmark, adapted to be removably connected to the outer surface 167 of the second side panel 134 at the option of the user, such as the dog's owner, handler or trainer. The user can place the at least one magnetically adhered accomplishment mark 172 on the side panel of the training box device 100 to keep track of the dog's accomplishments during the dog's training process. As exemplified in FIG. 4, the accomplishment chart 170 is preferably inscribed with words or abbreviations designating days of the week along a top row, and the accomplishment chart 170 is preferably inscribed with words or abbreviations designating tasks or goals for the dog 102 along a first column of the accomplishment chart 170.

Preferably, the bottom panel 104, the first side panel 124, the second side panel 134, and the front panel 114 are all constructed or fabricated of wood; and the brackets 146a, 146b, 150a, 150b, 154, 158a, 158b, and 162 as well as the fasteners 148a, 148b, 152a, 152b, 156, 160a, 160b, and 164 are preferably all fabricated from metal, such that the training box device 100 for a dog 102 is constructed of wood and metal. In such preferred embodiment, the fasteners 148a, 148b, 152a, 152b, 156, 160a, 160b, and 164 are metal lag screws.

In a preferred embodiment, as illustrated in FIGS. 1-5, the first side panel 124, second side panel 134, and front panel 114 of the training box device 100 are of equal height, relative to the respective extension upward from the bottom panel 104.

It can be appreciated from this disclosure that in other embodiments, the first side panel 124, second side panel 134, and front panel 114 of the training box device 100 are not of equal height, vertically, such that, for instance, the vertical height of the front panel 114 can be greater than or lesser than the height of the first side panel 124 and second side panel 134, relative to the respective extension upward from the bottom panel 104. In one preferred embodiment, a vertical height of the front panel 114 is lesser than a height of the first side panel 124 and second side panel 134, which are of equal height.

In another embodiment, the training box device 100 for a dog 102 is of unitary construction forged from a material selected from a group consisting of plastic, resin, high-density polyethylene, rubber, and steel. Thus, embodiments of the disclosed invention provide for a novel and unique device and method for efficient training of dogs, which exhibits superlative properties without being dependent on expensive or complex components.

Accordingly, as can be appreciated from the descriptions and illustrations herein, embodiments of the disclosed invention provide improved training of dogs in order to efficiently ensure that a pet owner's dog will develop into a confident and well-mannered family member, exhibiting proper behaviors, which improve the pet owner's everyday life with the dog.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This invention is susceptible to considerable variation within the spirit and scope of the appended claims.

All U.S. patents and publications identified herein are incorporated in their entirety by reference thereto.

The claimed invention is:

1. A training box device for a dog, comprising:
a bottom panel having a proximal end opposite a distal end, said bottom panel having a first side opposite a second side;
a front panel having a first side edge opposite a second side edge, said front panel having a bottom edge opposite a top edge, the bottom edge of the front panel fixed to and extending perpendicularly upward from the proximal end of the bottom panel;
a first side panel having a proximal end opposite a distal end and having a bottom edge opposite a top edge, the bottom edge of the first side panel fixed to and extending perpendicularly upward from the first side of the bottom panel, the proximal end of the first side panel fixed to the first side edge of the front panel;
a second side panel having a proximal end opposite a distal end, said second side panel having a bottom edge opposite a top edge, the bottom edge of the second side panel fixed to and extending perpendicularly upward from the second side of the bottom panel, the proximal end of the second side panel fixed to the second side edge of the front panel; and
a handle operatively connected to an outer surface of the front panel and configured to be grasped by a user's hand to maneuver said device.

2. The training box device for a dog of claim 1, further comprising a plurality of brackets and a respective plurality of fasteners, wherein said bottom edge of the first side panel is fixed to the first side of the bottom panel with the plurality of L-shaped brackets and the respective plurality of fasteners.

3. The training box device for a dog of claim 1, wherein the first side panel is welded to the bottom panel, wherein the first side panel and bottom panel are both forged from steel.

4. The training box device for a dog of claim 3, further comprising an accomplishment chart fixed to an outer surface of the second side panel, said accomplishment chart comprising at least one removably magnetically adhered accomplishment mark.

5. The training box device for a dog of claim 4, wherein the accomplishment chart comprises a first inscription of words designating days of the week along a top row of the accomplishment chart.

6. The training box device for a dog of claim 5, wherein the accomplishment chart comprises a second inscription of words designating training goals for the dog along a first column of the accomplishment chart.

7. The training box device for a dog of claim 6, wherein said at least one removably magnetically adhered accomplishment mark is in the form of a checkmark.

8. The training box device for a dog of claim 1, wherein said training box is forged from a material selected from a group consisting of plastic, resin, high-density polyethylene, rubber, and steel.

9. The training box device for a dog of claim 1, wherein said training box is constructed of wood and metal.

10. The training box device for a dog of claim 1, handle comprising a first end opposite a second end, said first end comprising at least a first fastener fixed to the front panel, said second end comprising at least a second fastener fixed to the front panel.
